(19) United States
(12) Patent Application Publication
(10) Pub. No.: US 2014/0372983 A1
(43) Pub. Date: Dec. 18, 2014

(54) IDENTIFYING THE INTRODUCTION OF A SOFTWARE FAILURE

(71) Applicant: Microsoft Corporation, Redmond, WA (US)

(72) Inventors: Anthony Martin Presley, Kirkland, WA (US); Eduardo J. Leal-Tostado, Sammamish, WA (US); Evan S. Wirt, Redmond, WA (US); Herman Widjaja, Sammamish, WA (US); Jeremy P. Buls, Bellevue, WA (US); Sankalp Gupta, Kirkland, WA (US); Sunilkumar Pillappa, Redmond, WA (US); Zaheera Valani, Redmond, WA (US); Zentaro K. Kavanagh, Los Angeles, CA (US)

(21) Appl. No.: 13/918,883

(22) Filed: Jun. 14, 2013

(51) Int. Cl. G06F 11/36

(52) U.S. Cl. CPC G06F 11/368
USPC 717/124

(57) ABSTRACT

The subject disclosure is directed towards a technology in which a first software version (e.g., build or check-in) that corresponds to a failure/regression is automatically identified. Software versions associated with a development order are automatically loaded and tested according to a search plan that narrows in on which version a failure condition first appears. For example, a binary search may be used that looks back to a previous version when a failure is detected on a tested version, or moves to a subsequent version when the failure is not detected. The search plan allows multiple test machines run tests in parallel on different versions, and adapts to the number of test machines available for testing.

### BACKGROUND

Large software systems such as operating systems and complex applications contain bugs. In general, as multiple teams work to create a product, the various teams make repeated changes to a product. Because many components and features are interdependent, any new change sometimes may have regressing effect on functionality in another component/feature. As a simple example, some change in a newly released software version may manifest itself in an application failing to launch correctly in the new version, even though the application never had a problem launching in earlier versions.

There may be many thousands of changes, such as builds or check-ins, (or other such units representing a change), between releases in which a failure or regression (these terms may be generally used interchangeably herein) is later discovered. In general, a failure corresponds to a bug or set of bugs that first starts in one of the one the builds or check-ins (or the like) among the possibly many thousands.

As a result, identifying this source of failure or regression is difficult and labor intensive. For example, sometimes before debugging can occur, it is helpful if the first build that caused the failure can be identified. A person (user) assigned to find the build needs to manually lookup and select appropriate branches/builds, then manually install a build, load and run the application or the like where the problem occurred, and observe the result to identify whether the currently installed build contains the regression. This typically needs to be repeated a number of times.

The problem is compounded when a product is highly complex, such as an operating system, as many applications depend on the operating system. Due to the typical delay between the time that a product was actually introduced and the time that the failure was noticed, which may be on the order of months, the user needs to evaluate the builds meticulously and repeatedly. In a successful case the user may spend on the order of a week to get this information.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more of various aspects of the subject matter described herein are directed towards automated identification of a failing/regressing first software version (or narrowed range of versions) among a plurality of ordered versions. In one or more aspects, a regression detection tool is coupled (e.g., via one or more test servers) to a plurality of test machines. The regression detection tool includes logic that when executed causes a plurality of different software versions to be loaded on the test machines. The logic may be configured to search (e.g., via binary searching) for a narrowed subset comprising at least one version that corresponds to a failure condition based upon results of running a test job on the different software versions. The logic may be configured to do automated and/or manual searching; for example, the user can choose specific versions (e.g., builds) or the system can choose via sorting algorithms.

One or more aspects are directed towards searching among software versions to determine a software version that corresponds to a failure condition. Machines are loaded with different versions based upon a search plan and a number of machines available. A test is running on one or more of the loaded versions to detect whether the failure condition occurs on each tested machine. If so, the search is narrowed based upon the search plan until a version or range of versions is identified corresponding to where the failure condition first occurred.

One or more aspects are directed towards loading a software version onto a test machine, in which the software version is one of a plurality of software versions associated with a software development order. A test is run on the test machine to obtain current test results. Described is repeated testing to search (e.g., binary searching until a stopping criterion is met) for which versions fail. If a tested version does not fail, results of a test of a subsequent version are obtained; if a test fails, results of a test of a previous version. Searching repeats until the stopping criterion is met, with data output that identifies version or ranges of versions corresponding to where the failure occurred among the plurality of software versions.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example system for determining which software version or versions correspond to a regression/failure condition, according to one or more example implementations.

FIG. 2 is a block diagram representing an example test tool that executes tests according to a search plan to find a regressing software version according to one or more example implementations.

FIGS. 3A-3C are representations of example searches run on versions (e.g., builds) arranged in build line development order, according to one or more example implementations.

FIGS. 4A and 4B are representations of example other searches run on versions (e.g., builds) arranged in build line development order, according to one or more example implementations.

FIG. 5 is a flow diagram representing example steps that may be taken to determine which software version or versions correspond to a regression/failure condition, according to one or more example implementations.

FIG. 6 is a block diagram representing an exemplary non-limiting computing system or operating environment into which one or more aspects of various embodiments described herein can be implemented.

### DETAILED DESCRIPTION

Various aspects of the technology described herein are generally directed towards helping to automatically identify the first change (e.g., build or check-in) in a software product, (e.g., an application, application framework or operating system), where a regression or failure was first introduced. The technology may find regressions retroactively, e.g., after a product is released and a regression is detected “in the field,” and also allows developers to proactively capture regressions early and investigate them effectively. For example, a tester can detect a regression before any software release, including to identify at what point in the development/revision process the regression became introduced so that the problem is resolved before being released.

As used herein, “regression” and “failure” refer to the same concept and are generally used interchangeably. Further, “version” refers to a software product at a certain state in its development; for example, a unit of change such as a build may be referred to as a version, and so is any different unit of change, such as a check-in. Note that a product's version and its product release are independent concepts; for example, there may be many thousands of changes, each corresponding to a different version, between two product releases. Note further that a version, such as a build, may have branches therein that are subunits of a larger change, and that the search may be down to the subunit level. Notwithstanding, while version refers to build, check-in or any other unit of change that various enterprises may use to maintain and track product changes, many of the examples herein refer to one or more “builds,” as this term is generally well-known and commonly used in the art.

In one aspect, a regression detection tool automatically searches among different versions to determine at which version or range of versions a failure first appeared. As part of the search, the regression detection tool may direct that different versions of the product be automatically installed on one or more test machines to run a test thereon. The test may be created by a user (the tool user or another user) in the form of software code such as a script that runs the test and automatically verifies whether the failure occurs in a given version or not. Instead of automated failure detection, a test may be configured so that the user may manually look at the state of the test machine after the test is run to determine whether the failure occurred.

In one aspect, a binary search and/or other search techniques may be used to narrow in on the first one in which the failure occurs. The user of the tool can participate in the search to the extent desired, e.g., to search manually or automatically using any other user-defined build selection criteria. A search may be to a certain level, including to automatically identify an individual code change that caused a failure, or a range of changes in which the failure occurred.

The tool may be customized, such as to match the way in which a product's changes are maintained. For example, different software products may have different ways in which version changes are tracked, e.g., by check-in, or by build, including branches within a build, and so on. For example, one product may track changes daily regardless of their source, while another product may have changes tracked in some other way, such as by development group, e.g., several groups may have sets of changes on the same day.

It should be understood that any of the examples herein are non-limiting. For example, while various camera and projector/emitter arrangements are exemplified herein, other arrangements may be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and testing in general.

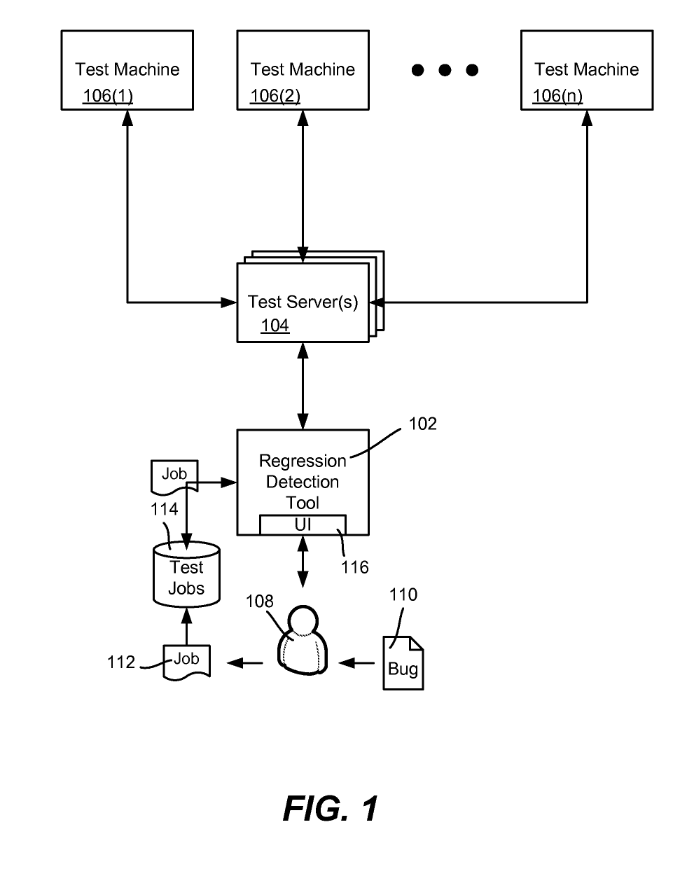

FIG. 1 shows an example system in which a regression detection tool 102 is couple to a set of one or more test servers 104, which in turn are coupled to test machines 106(1)-106(n). In general, a user 108 is informed of a failure (e.g., bug 110) and is instructed to determine in what software change unit or subunit the failure first appeared.

The user 108 may save and/or schedule the test as a job 112, in which event the test may be added as a test job to a set of test jobs 114. If scheduled, the regression detection tool 102 runs the test job, e.g., as directed by a scheduler component. Alternatively, the user 108 may run the test directly via a user interface (UI) 116. Note that the user may interact with the user interface 108 to save/schedule a job in the set of test jobs 114, or may do so via another program. For purposes of simplicity, the examples herein refer to a user interfacing directly with the user interface 116 to run a job, although it is understood that the job may be saved and scheduled, and/or that the job may be generated on a separate device/program and communicated to the regression detection tool 102 and/or stored in the set of test jobs 114.

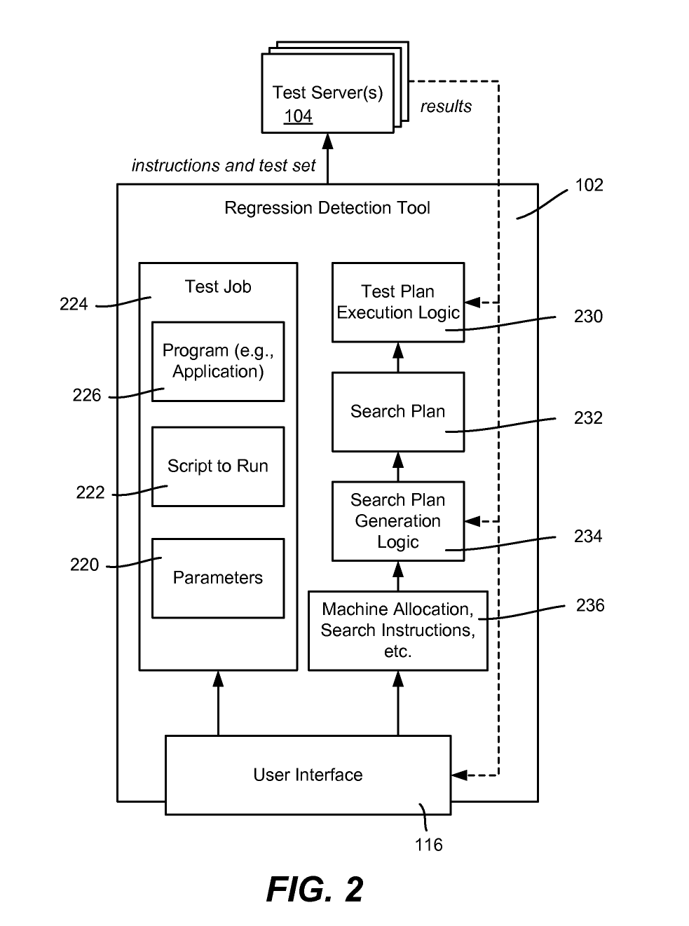

As generally represented in FIG. 2, the regression detection tool 102 interfaces with the user via the user interface 116, such as to obtain parameters 220 and a script 222 (or the like, such as any executable code) for running a test job 224. Parameters 220 and/or the script 222 may be used to recreate certain conditions associated with the failure, e.g., those needed to cause the failure in the problematic versions. The script 222 may be used, for example, to automatically launch an application once a particular software version is loaded, set up proper conditions using any parameters, emulate interactions such as keystrokes or mouse events needed to get to a certain failure point, and so on. Depending on the type of failure, automatic detection of the “failed” or “not failed” state may be included in the script or other such code. Manual detection of the “failed” or “not failed” state also may be facilitated, such as to let a user decide the failure state, which may be useful it the failure crashes the machine and the machine cannot report its results; (although an external heartbeat mechanism may be able to detect crashes). Note that other information may be logged with a failure (or non-failure) condition, such as information that later may be used in debugging.

The test job 224 also may include the program code 226 in which the failure appears. For example, if an otherwise compatible application program has a bug that surfaces with a latest-released operating system version, then that application program code (which may be a particular version thereof) needs to be available to the system to load and test along with the different operating system builds. Note that instead of the program code itself, a reference to the program may be included as part of the test job from which the program may be loaded; (such a reference may be written into the script or other code that performs the test). Note further that more complex arrangements may be tested, e.g., some application X fails with a particular release, but only when some other application Y is already loaded. Thus, the code for program X and program Y need to be available to test, whether via the test job or via a reference to an accessible storage location that contains the code.

Also shown in FIG. 2 are test-related components, including logic 230 that instructs a test server (or more than one) what to do to execute the test job 224. Note that the logic 230 may directly interact with the test machines 106 (FIG. 1) to run a job, however the servers 104 are advantageous in many scenarios, such as to load builds, (which are accessible to the test servers), balance resources, and so on. For example, a pool of test machines and/or other resources may be available, and the test servers 104 may determine (e.g., using well-known scheduling algorithms) how to arrange a set of scheduled jobs in a way that attempts to maximize resource pool usage and therefore job throughput.

Turning to another aspect, in general, the more test machines that are available to test the versions, the faster the determination as to in which version a recognized failure was first introduced. In general, it takes time to configure a machine for a test, including loading the machine with a build to evaluate and typically some additional code. Depending on the steps needed to the test for whether a build corresponds to a failure, the test also may take some time to run. Thus, parallel machines are leveraged to run tests to the extent available, (where “parallel” refers to at least some overlap in time, e.g., some loading and/or testing may be occurring operations at the same time).

Note that in some instances, the test machines may be virtual machines, such as to have each virtual machine loaded with a different build. In other instances, this is not practical or viable, e.g., when a component being tested is one that would be shared among multiple virtual machines if used. Thus, as used herein, “machine” refers to part or all of the resources of a single physical machine, a combination of physical machines, one or more virtual machines, and/or any combination of physical and/or virtual machines.

The way in which the builds are loaded and tested also determines how long a search takes. For example, if hundreds or thousands of versions exist between a previous release and a new release in which a failure was detected, the failure may have first occurred in any of those versions. Thus, as shown in FIG. 2, a search plan 232 is generated by search plan generation logic 234, based upon data 236 the number of test machines available, how the user wants the machines allocated, how the search or searches are to be executed, and so on. A linear search may be chosen by the user, but this (in many instances) is inefficient compared to a binary search. Thus, one type of search plan 232 described herein is based upon binary searching strategies, which may be used because the versions/units of change (e.g., builds) are in order from the last known good configuration to the most current known failure configuration (or vice-versa). Depending on a given need, other sorting mechanisms including linear, bubble, customized sorting mechanisms may be used instead of or in addition to binary searching.

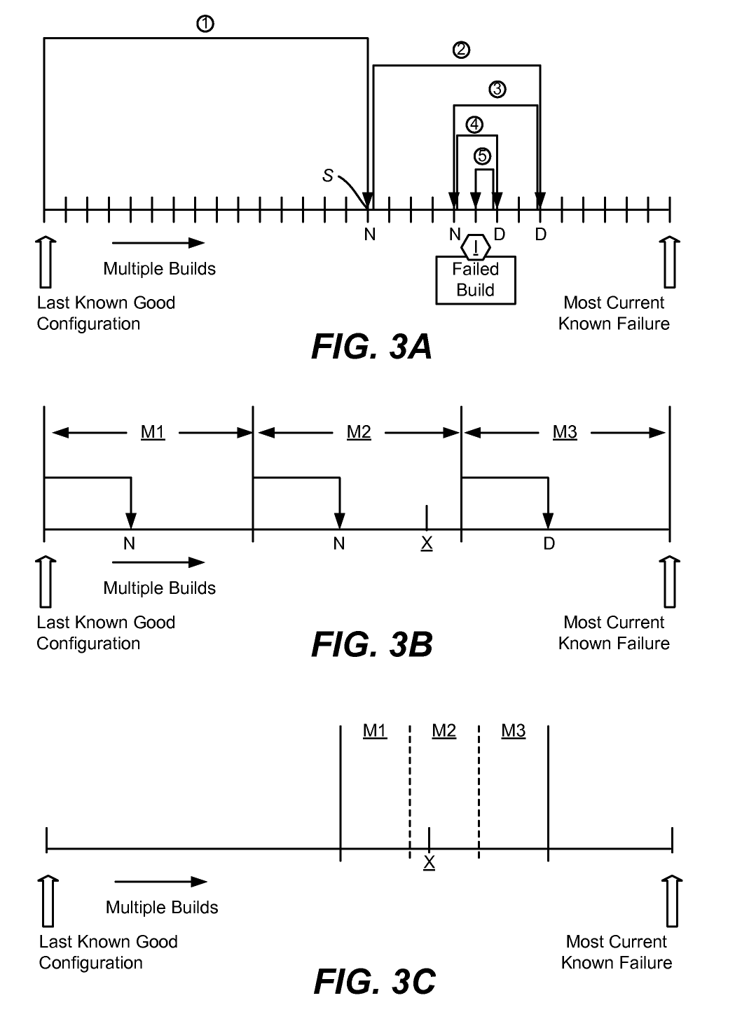

FIG. 3A shows an example straight binary search plan performed from a middle starting point S, which as can be seen by following the numbered arrows from one (1) to five (5), quickly narrows the search to the first failing build, identified as I. Note that below each decision point, an “N” means the test did not detect the error yet as of this test point, and thus moves forward to test a subsequent build, whereas a “D” means the test at this point did detect the error, and thus moves back to test a previous build.

Because in this usage model binary searching branches based upon a machine's test result, which in this instance is “failure “not-detected” or “failure detected,” the search may be performed using as little as one test machine. However, more machines may be available to use, and thus the search plan may be generated to match the desired type of search to the number of machines.

A straightforward way to use multiple machines is to divide the search space based upon the number of machines into subspaces, and have each machine start in one of the subspaces. This is represented in FIG. 3B, where three machines M1 M2 and M3 are available, with each assigned to search one-third of the total space to find the unknown build (represented by “X” on the build line). Note that builds are arranged left to right represented as “build line” from the last known good configuration (e.g., some release) to the most current known failure configuration (e.g., some newer release).

As soon as each machine has completed its test, the subspace can be narrowed based upon the results at each; (note that “results” may be one or more results, e.g., a single not fail/fail test result may be considered “test results” as used herein). For example, in FIG. 3B, the first failing build X is known to be to the right of the rightmost (not detected yet) “N” which was determined by machine M2, and to the left of the leftmost “D” (detected) as determined by machine M3. Thus, as shown in FIG. 3C, the search space may be further narrowed to new, smaller subspaces that the machines can similarly search, honing in on the final point X at each next level of search.

In on alternative, as only one branching decision at a time is made based on the test results, loading different builds in parallel machines (and possibly running the test) may be performed in advance, in anticipation of that machine (its test results) being needed, which also may save significant time. In other words, in a binary search, the first decision point (build to test) is known, as well as the next two possible decision points, (and so on for those next level decision points). If three test machines are available, for example, loading the three servers obtains substantially parallel results for the first and second level decision points.

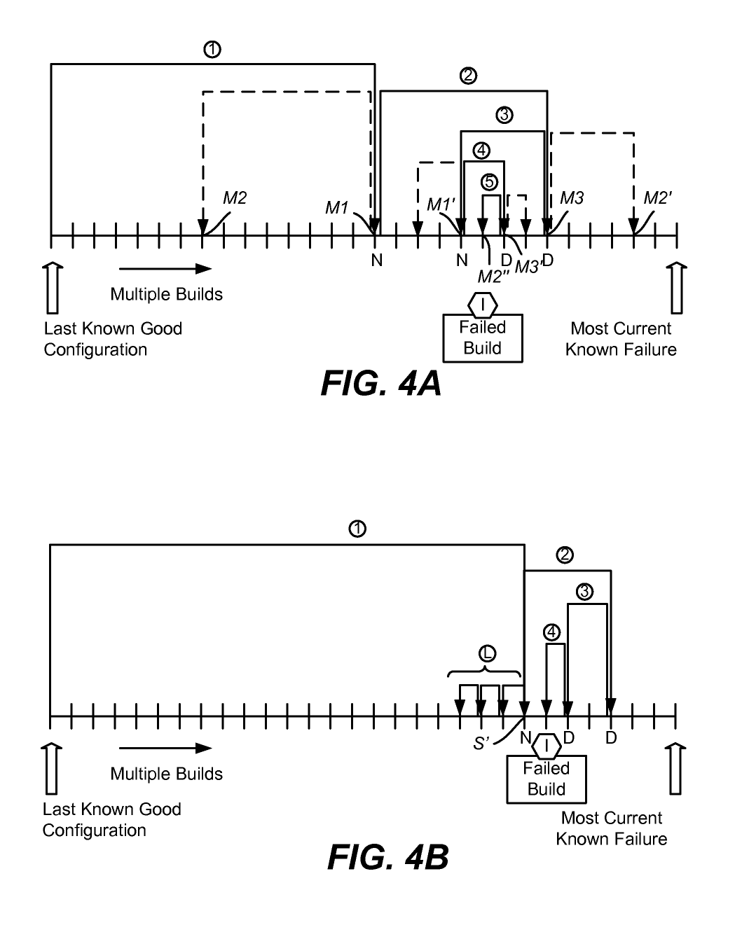

By way of example, consider that three machines M1-M3 are available in a straight binary search as represented in FIG. 4A. One machine M1 is assigned for loading the “middle” build and running the test that will determine the next branch direction of the binary search. The other two machines M2 and M3 are assigned for loading and running the test at each of the two next possible builds to which the binary search can branch. In this way, one of the two other machines will provide a needed decision, substantially in parallel.

In the example of FIG. 3A, the test on machine M1 does not detect the issue, (as indicated by the “N” below the end of the arrow one (1), whereby the binary search moves forward among the builds (arrow two (2)) to the build evaluated at machine M3. Note that had the issue been detected, the search would have moved backward to a previous build, e.g., as indicated by the dashed arrow to machine M2. The results at machine M2 are generally discarded. At this time, the builds in machines M1 and M2 are not needed, whereby those machines may be reloaded with new builds relative to the next anticipated binary search locations, shown in FIG. 3A as machine M1′ and machine M2′.

The results at machine M3 (which may already be available as the loading and test was run in parallel with the test on machine M1) determines the next search direction. As can be seen in FIG. 3A, in this example machine M3's test result causes the search to branch (arrow three (3)) to machine M1′ and not to M2, (the dashed arrow). Note that M1′ may be still loading the build or executing the test, however machines M3 and M2′ may be freed (M2′ also may have been still loading the build and/or executing the test but may be freed for reloading since its decision is not needed).

As can be seen by following the labeled solid arrows in this example, in which a non-detected failure state (N) branches right to a subsequent build and a detected failure state (D) branches left to a previous build, the search identifies the first build at which the failure was detected. Note that not every machine is shown at an arrow point in FIG. 3A, but it is understood that unneeded anticipatorily loaded machines may be reloaded as soon as they are determined to be outside the new search range.

Anticipatory loading and testing in many instances may be more efficient on average than subspace searching. Notwithstanding, an anticipatory-type search plan may be combined with a subspace-type search plan.

Note that as many machines as available and needed may be used in the anticipatory technique. For example, if six machines are available for a straight binary search, a first machine is loaded with the first level decision making build, and a second with one of the two other builds based upon the next branch possibilities. The three remaining machines can cover three of the next four possibilities. Assuming the build at issue may be anywhere statistically and that there are the same number of builds on the left and right side of the decision-making builds, the next test level provides a parallel result that can be used seventy-five percent of the time.

In any event, the parallel loading and testing operations reduce a significant amount of waiting time. As can be seen, the search plan not only finds the build that corresponds to the failure, but also determines in what order which builds are loaded in which machines for testing.

The test plan generation logic 234 (FIG. 2) may adapt dynamically as machines are added or removed. Thus, whenever a number of available machines changes, a new plan may be generated, factoring in the number of machine and the number of builds remaining to be tested. When the number of builds remaining to test drops to less than the number of machines, the machines can be freed for other purposes, including to test another bug, or for an entirely different purpose unrelated to testing.

A binary search need not start at the middle of the builds. For example, based upon user knowledge, or statistics/trends from other searches, the test may start somewhere else along the build line. By way of example, consider that a tester knows (or statistics show) that a number of failures are being detected somewhere along the build line, such as just after a milestone. The user may specify that the test start at a non-central starting point S (FIG. 4B). Note that statistics be used to automatically change the starting point, or recommend a starting point to a user. Further, random sampling may be done to attempt to narrow a range of versions to test.

Further, it is possible that the “last known good configuration” is not really known, but a starting version is chosen so that a binary search can take place. Before starting such a search, a test of the starting version may be performed, because it is possible the failure already exists with this starting version. Thus, any binary search will not find an answer, whereby if desired, an earlier version needs to be chosen as the starting version, with the former estimated starting version known to be the most current known failure. Similarly, it is possible that the last version be tested to determine whether it really is a “most current known failure,” before using resources for a binary search. This allows a tester to check a range, for example, before starting a search.

More than one search may be performed at a time, (as in subspace searching), but need not be limited to binary. For example, consider that in FIG. 3B, the user strongly suspects (or statistics show) that a build somewhere after a starting point (such as a milestone) is likely to have the first failure, but that it is still possible that the issue may be just before that starting build. The tester may allocate machines for binary and/or linear searching, such as to specify that a binary search from that starting point plus a simultaneous other search be performed at the same time, e.g., a linear search L (or possibly another binary or even a random search, in the other suspected range). A second search can be conditional, e.g., start a linear search backwards from some starting point if the binary search goes towards a previous version.

The results of one search can used by or even cancel another, e.g., once the binary decision “N” is made at the end of arrow (1) in FIG. 2B, earlier builds need no longer be tested. Note that because simultaneous searches can overlap, the test plan execution logic also may track completed tests, so that the same test of a version need not be performed more than once to use the test's results.

Still further, tests may be arranged scheduled to use an already loaded configuration. For example, consider that a tester wants to locate the first builds for two different bugs in the same program. Two (or more) parallel searches may be conducted, e.g., one for each bug, as long as the failures are not of a type that interfere with the other's results.

Still further, rather than free a machine with a loaded version, that version may remain loaded for another test, e.g., from another tester, for another bug and so on. For example, consider that tester A wants to run a test D on version J and tester B (or possibly tester A again) wants to run a test E on the same version J. Rather than freeing the machine, it may be more efficient to run the different test on the machine already configured with version J (likely after a reboot so that test D does not interfere in any way with test E). Scheduling and/or resource management solutions may be used to figure out an efficient way to run tests against versions using a pool of resources that are intelligently allocated based upon their configuration.

When testing, a time limit may be enforced. For example, if a user specifies a time to complete, the testing will be performed to the extent possible until either one version (or subunit thereof) is identified or the time limit is reached. If the time limit is reached, the output from the tool may be a range of version in which the failure first appeared rather than a single version. A user also may specify from the start that a range is a sufficient identification, rather than a specific version. Note that a “fuzzy” time limit may be enforced, e.g., do not start loading another machine after N hours, so that, for example, machines already being loaded or running a test can complete what was started.

Once a version is determined to have been the first build where a failure occurs, a search may be performed on subunits of the version in the same way. Subunits may be separable by one or more criteria, typically branches corresponding to different states of revisions. A test may be performed by loading the code of each branch/sub-branch to see if where the failure appears. Branches or sub-branches thereof that are arranged in time order may be searched with a binary search. A test may specify a unit or subunit level to which a test is to evaluate code, as well as which branch or branches to search, e.g., based on metadata associated with each branch, such as per team.

In addition to testing software configurations, hardware configurations, including with corresponding drivers may be tested. For example, if different machine configurations are available, a set of versions to test may be tested per machine configuration, e.g., in a second dimension of testing. As a one example, the same set of versions may be tested on one set of test machines configured with less than 4 GB RAM, and another configured with more than 4 GB of RAM. Any practical number of dimensions may be tested. A change list also may be searched.

It should be noted that the regression detection tool may leverage existing technologies. For example, manually controlled tools/servers that already assist in loading different versions onto test servers for testing may be used by the regression detection tool, e.g., by simulating manual control through a suitable interface.

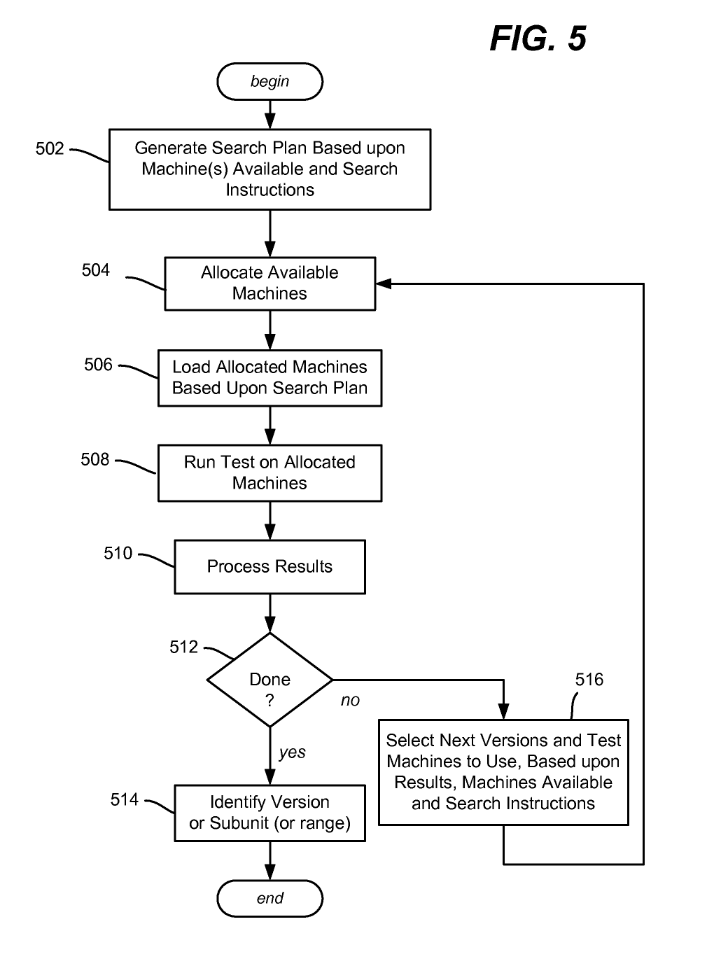

FIG. 5 is a flow diagram comprising example steps that summarize some of the aspects described herein, beginning at step 502 where the user or scheduler or the like has provided a test job. Step 502 represents generating the search plan based upon the number of machines available and the test job's instructions. For example, for a straight binary search, the initial search space may be subdivided among machines, for example, or one machine may be associated with the search starting point with other machines associated with the next anticipated branch locations and so on. Step 504 allocates the available, machines according to the plan. Step 504 may, for example, have one machine allocated for linear searching and three machines allocated for binary searching according to the search plan.

Step 506 represents the loading of the allocated machines based upon the search plan, e.g., loading different versions to test in each allocated machine, along with any other needed code, e.g., an application program to test over different operating system versions. Step 508 runs the test on each machine. Note that steps 506 and 508 are parallel per machine, e.g., one machine may load faster than another, and the test can be run on that machine without waiting for the other machine to complete its loading.

Step 510 processes the results of the test. Note that manual intervention may be needed to obtain the results in some scenarios, e.g., the user has to tell the tool whether a failure occurred on a given machine.

After processing the results, the tool may be done, as evaluated at step 512. For example, the tool may have identified the first problematic version or subunit, or reached the desired range of versions or subunits, or the test may have timed out. Alternatively, the user may have manually stopped the search. If so, step 514 outputs the results, e.g., the version or subunit corresponding to the failure, or some narrowed subset thereof corresponding to a failure range in which the failure is known to have occurred.

If not done at step 512, based upon the results, step 516 selects the available machines and the versions to test for the next level of testing. As described above, the number of machines available may have changed, e.g., a greater or lesser number of machines may now be available than before, whereby the search plan adapts, e.g., internally or by being regenerated. Note that during a test a machine may be lost due to unexpected machine failure (not because of an expected test crash) or because of losing a machine based upon some priority scheme. Losing a machine during a test may be handled by retesting on a different machine, and is not described hereinafter. Losing a machine before a next test is run is adapted to in the next search plan. Step 516 also may free machines that are no longer needed, e.g., because the search has been narrowed such that there are less remaining tests needed than machines available.

As can be seen, there is described a technology corresponding to a tool that selects appropriate versions (e.g., builds) based on search decisions of a test job and its results. A manual mode may be provided, but an automated or semi-automated mode allows automatically setting up test machines and running tests until a regressing version is found.

### Example Operating Environment

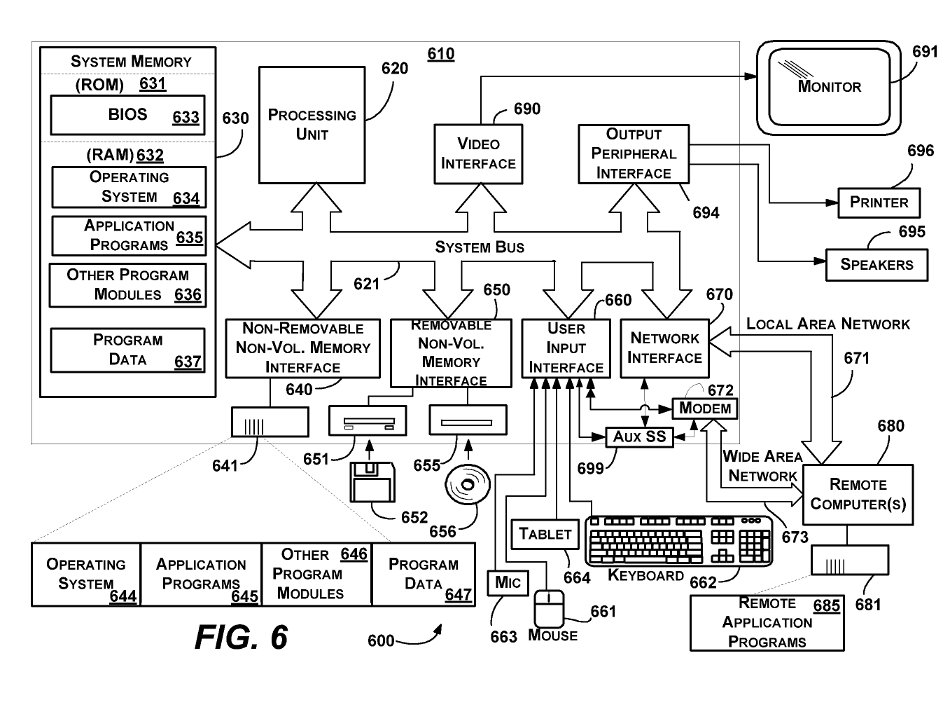

FIG. 6 illustrates an example of a suitable computing and networking environment 600 into which computer-related examples and implementations described herein may be implemented, for example. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the example operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an example system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are examples and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System on chip systems (SOCs), Complex Programmable Logic Devices (CPLDs), etc.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method performed at least in part on at least one processor, comprising, searching among software versions to determine a software version that corresponds to a failure condition, including loading a plurality of machines with different versions, in which different versions are based upon a search plan and a number of machines available, running a test on one or more of the loaded versions to detect whether the failure condition occurs on each tested machine, and if so, narrowing the search based upon the search plan until a version or range of versions is identified corresponding to where the failure condition first occurred.

2. The method of claim 1 wherein the search plan specifies a binary search, and further comprising, dividing a search space into a plurality of subspaces based upon the number of machines available and searching each subspace with a binary search.

3. The method of claim 1 wherein the search plan specifies a binary search, and further comprising, selecting a version for loading in a machine based upon where the binary search is to begin, and selecting one or more other versions for loading in one or more other machines in anticipation of where the binary search is able to branch in subsequent tests.

4. The method of claim 1 wherein the search plan specifies a starting point for a search, and wherein searching comprises beginning the search at the starting point.

5. The method of claim 4 further comprising, determining the starting point based on statistics from other searches.

6. The method of claim 1 wherein the search plan specifies at least two searches, and wherein searching comprises performing at least part of each search in parallel with one another.

7. The method of claim 1 wherein the search plan specifies time criterion, and further comprising, stopping the search based upon the time criterion.

8. The method of claim 1 wherein the search plan specifies a version search and a subunit search, and further comprising, stopping the version search when an individual version is identified, and running a subunit search on at least one subunit of that individual version.

9. The method of claim 1 further comprising, modifying the search plan based upon a change to the number of machines available.

10. A system comprising, a regression detection tool, the regression detection tool coupled to a plurality of test machines and configured with logic that when executed causes a plurality of different software versions to be loaded on the test machines, and wherein the logic is configured to search for a narrowed subset comprising at least one version that corresponds to a failure condition based upon results of running a test job on the different software versions.

11. The system of claim 10 wherein the regression detection tool is coupled to the plurality of test machines via one or more test servers that load the versions onto the test machines.

12. The system of claim 11 wherein the logic executes a search plan to run the test job in parallel on a number of machines loaded with the different versions based at least in part on the number of machines available.

13. The system of claim 12 wherein the search plan includes data specifying a binary search, and wherein the logic is configured to cause the plurality of different software versions to be loaded on the test machines based upon one or more anticipated branches of the binary search.

14. The system of claim 10 wherein the regression detection tool includes a user interface by which search instructions may be input.

15. The system of claim 10 wherein the regression detection tool is coupled to a test job data store containing one or more saved test jobs.

16. The system of claim 10 wherein each version comprises a build or a check-in.

17. One or more machine-readable storage media or logic having—executable instructions, which when executed perform steps, comprising:
(a) loading a software version onto a test machine, in which the software version is one of a plurality of software versions associated with a software development order;
(b) running a test on the test machine to obtain current test results;
(c) determining whether the current test results correspond to a failure of the version, and
(i) if so and a stopping criterion is not met, obtaining test results from a previous version as the current test results and returning to step (c), and
(ii) if not and a stopping criterion is not met, obtaining test results from a subsequent version as the current test results and returning to step (c),
and
(d) if a stopping criterion is met, outputting data identifying a version or ranges of versions corresponding to where the failure occurred among the plurality of software versions.

18. The one or more machine-readable storage media or logic of claim 17 wherein obtaining the test results from the previous version comprises (a) loading the previous version and running the test with the previous version to obtain the test results, or (b) using the test results from an already-run test of the previous version, and wherein obtaining the test results from the subsequent version comprises (a) loading the subsequent version and running the test with the previous version to obtain the test results, or (b) using the test results from an already-run test of the subsequent version.

19. The one or more machine-readable storage media or logic of claim 17 having further computer-executable instructions comprising, selecting the previous version or the subsequent version based upon binary search techniques.

20. The one or more machine-readable storage media or logic of claim 17 having further computer-executable instructions comprising, loading the previous version and the subsequent version in parallel with loading the software version at (a).
